(19) United States
(12) Patent Application Publication
(10) Pub. No.: US 2006/0147657 A1
(43) Pub. Date: Jul. 6, 2006

(54) Image recording medium

(75) Inventor: Neil Loeb, New York, NY (US)

Correspondence Address: FITCH EVEN TABIN AND FLANNERY, 120 SOUTH LA SALLE STREET, SUITE 1600, CHICAGO, IL, 60603-3406, US

(73) Assignee: Heirloom Archive, LLC.

(21) Appl. No.: 11/283,613

(22) Filed: Nov. 21, 2005

Related U.S. Application Data
(63) Continuation-in-part of application No. 10/376,414, filed on Feb. 28, 2003.

(51) Int. Cl. B41M 5/00

(52) U.S. Cl. 428/32.1

(57) ABSTRACT

An image recording medium is provided that includes a support substrate, a foamed primer contacting the support substrate, and an opaque ink receptive coating contacting the foamed primer. The image recording medium has white point of 95 of greater and a brightness of 95 or greater.

This application is a continuation-in-part application of U.S. Ser. No. 10/376,414, filed on Feb. 28, 2003, which is incorporated herein by reference.

The present invention relates to an image recoding medium and methods for preparing an image recording medium. More particularly, the image recording medium includes a combination of a support substrate layer, a primer layer and a ink-receptive layer that together are effective for providing an image recording medium with a high white point, good ink absorption, good color development, and which maintains subtle textures of the substrate.

### BACKGROUND

The applications of digital imaging technologies have grown extensively in recent years. More applications of imaging technology become apparent as the costs of implementing these technologies continue to decline and the complexity of imaging programs increases. These applications range from the relatively commonplace, such as document imaging, to the relatively obscure, such as virtual reality imaging. It is becoming apparent that the market potential of computerized imaging techniques is only just beginning to be recognized.

Among the many existing and potential applications of imaging technologies is the digitized imaging of photographs, paintings, and the like, and facsimiles thereof. Once such images are obtained in digitized form, either by conversion of an analog original or by direct production, as with a computer-aided design (CAD) system, they can be manipulated in a virtually unlimited number of ways. For example, the images can be enhanced with respect to color, contrast or size, and even manipulated onto a different image.

A typical imaging system includes a computer having an adequate storage medium to record the image to be processed, an image production device, such as a scanner, to digitize the original image, an image processor, which is designed to speed up the available image manipulations, and an output device where the processed image is received. Although each of the above-mentioned components of a typical imaging system continues to develop as the technologies advance, the ultimate stage of image processing, specifically, the transfer of a processed image onto a desired medium, is of particular interest herein.

The printers employed in these technologies include dot-impact printers, laser printers, thermal printers, ink-jet printers and the like, of which ink-jet printers and ink-jet plotters are most widely employed because these machines have advantages that include printing that can be performed with little machine noise and in full color. Additionally, the comparatively low cost and convenient use of ink-jet printers make such printers the generally preferred devices for recording processed images. Regrettably, the acceptability of the recorded images produced with ink-jet printers is, quite frequently, extremely dependent on the recording medium. Typically, the recording medium used with an ink-jet printer is paper, which is provided as a plain-type or coated-type paper. However, for many applications, such as for the imaging of paintings or advertisements, paper is not a suitable recording medium. Preferably, alternate recording media or substrate that would be used under these, and other, circumstances include canvases, textiles, leathers, and polymer sheets.

Typically, the substrate used in printing in an ink-jet printer or ink-jet plotter can be coated with an ink-receptive layer, or can include a plastic film recording sheet provided with an ink-receptive layer on at least one surface of the substrate. Recording sheets of this type are widely used in the preparation of posters having colored images because the printed material obtained by printing out on such a recording sheet is in the gloss of the surface. Unfortunately, such ink-receptive layers are transparent and printing is completed on top of the ink-receptive layer, creating in an appearance akin to writing on the surface of a mirror. Moreover, peeling of the ink-receptive layer is often problematic, often resulting in the loss of the entire ink-receptive layer.

Various coating compositions have been proposed heretofore for forming such an ink-receptive layer on a substrate to prepare an ink-jet recording sheet, including, for example, coating compositions comprising a polyvinyl alcohol and polyvinylpyrrolidone. Due to the hydrophilic nature of these polymers, however, the ink-receptive layer has low water-resistance so that use of the recording sheets outdoors or under a highly humid atmosphere is limited along with a disadvantage of blocking of the sheets stacked on one another.

One of the major concerns in using any recording medium is the extent to which the medium permits “print through” of ink and the extent to which the medium resists ink absorption. In the case of “print through,” the ink penetrates through the medium and can readily be perceived from the opposing surface. This is particularly problematic where sizeable amounts of ink are utilized, as in full-color printing. Conversely, whenever the print medium resists ink absorption, blotting or feathering of ink on the surface can occur since the ink is not sufficiently absorbed into the medium.

Commonly, a sizing agent that fills the pores of the recording medium is engaged in an effort to give the medium the desired balance of ink absorptivity and penetration resistance, especially when the medium would otherwise have excessive ink penetration. However, it has been found that sizing agents tend to migrate over time in the recording medium, thereby causing changes in the ink absorptivity of the medium and reducing overall print quality of the recorded image. Moreover, such sizing agents fill the pores, and therefore do not permit the subtle textures of the recording medium or substrate to be maintained.

In other situations, the desired recording medium resists ink penetration excessively, such as with nonporous or coated porous substrates. One example of the latter kind of substrate is that of porous corrugated packages coated with clay-based or other coatings. These particular coatings improve the flexographic printing properties of the packages. A method to correct the poor ink absorptivity for ink-jet printing of these packages involves reformulating the water-based inks to include acrylic-based or alcohol-based formulations. However, reformulating the inks likely would require making adjustments to printheads and other machine components.

Recording materials including a nonporous base material and a surface recording layer formed thereon have been proposed where the surface recording layer purportedly is formed at least with a surface active agent that does not form an insoluble material in the ink, and optionally, is formed with a binder agent which is soluble in or swells in an aqueous ink. The charge of the surface active agent, e.g., cationic, anionic or neutral, in the surface recording layer apparently must be matched with the charge of the dye present in the ink composition.

Although much energy has been expended on adapting paper and paper-like media for use with high-speed printers, such as full-color ink-jet printers, little attention has been paid to either altering low quality substrate materials so as to yield a substrate that mimics the qualities of high quality substrate materials or maintaining the subtle textures of the substrate. Accordingly, it is desired to provide a novel coating for substrates that can be used in conjunction with printers in the offset print, wet print, ink-jet print, ink-coat, and digital imaging industries, in which there is high white point, high ink absorptivity, acceptably low “print-through” characteristics, and yet permits the subtle textures of the substrate to be maintained. In particular, it is desired to provide novel coating prepared for application on such substrates as canvas, textiles, polymeric sheets and films, and paper products. Recording media treated with such a novel coating are expected to offer qualities, such as improved aesthetics, clarity, durability, and the like, typically associated with conventional paper and other fibrous materials of higher quality

### SUMMARY

The present invention provides an image recording medium that can be used in conjunction with printers in the offset print, wet print, ink-jet print, ink-coat, and digital imaging industries. The image recoding medium includes a combination of layers that together are effective for providing an image recording medium with a high white point, brightness, good ink absorption, good color development, and which maintains subtle textures of the substrate. The enhanced white point and brightness provide a image recording medium with an expanded color range that is especially useful for photographic and art applications.

The image recording medium includes a bleached and sized support substrate, a foamed primer contacting the support substrate, and an opaque ink receptive coating contacting the foamed primer. The support substrate may include canvas, recycled paper and brown paper. In an important aspect, the support substrate is canvas.

The image recording medium further includes a primer layer which provided by priming the support layer with an acrylic primer blended with surfactant and titanium dioxide (TiO₂). In this aspect, the acrylic primer has at least about 40 weight % solids, preferably about 48 to about 52 weight % solids, about 0.1 to about 0.8 weight % surfactant, preferably about 0.4 to about 0.6 weight % surfactant, and about 18 to about 26 weight % TiO₂, preferably about 23 to about 25 weight % TiO₂. The components of the primer are effective for providing a primer layer with a white point of about 84 or greater and a whiteness of about 89 or greater.

The image recoding medium includes an ink receptive coating layer which is applied onto the primed support substrate. In this aspect, the ink receptive coating layer is a resin-based coating that includes at least about 9 weight % solids, in one aspect about 9 to about 15 weight % solids, in another aspect about 20 to 30 weight % solids, and in another aspect about 22 to about 24 weight % solids. The ink receptive coating further includes about 4 to about 10 weight % TiO₂, preferably about 5 to about 7 weight %, and most preferably about 6 weight % TiO₂. The ink receptive coating has an opacity of about 73% or greater, a white point of about 95 or greater, and a brightness of about 95 or greater.

In another aspect, a method is provided for producing an image recording medium. The method includes preparing a substrate by bleaching and sizing the support substrate, foaming a primer and applying the foamed primer to the substrate, wherein the foamed primer is an acrylic based primer with surfactant, and applying an opaque ink receptive the primer. In an important aspect, the primer is foamed by injecting air into a blend of acrylic primer, surfactant and TiO₂. The foamed primer is applied to the support substrate and dried. The primer support substrate is then passed through rollers to supply a force of at least about 7 tons per square inch to the primed support substrate. The method is effective for providing an image recording medium having an opacity of about 73% or greater, a white point of about 95 or greater, and a brightness of about 95 or greater.

### BRIEF DESCRIPTION OF FIGURE

FIG. 1 is a comparison of images printed on image recording medium as claimed (FIG. 1A) and standard image recording medium (FIG. 1B)

### DETAILED DESCRIPTION

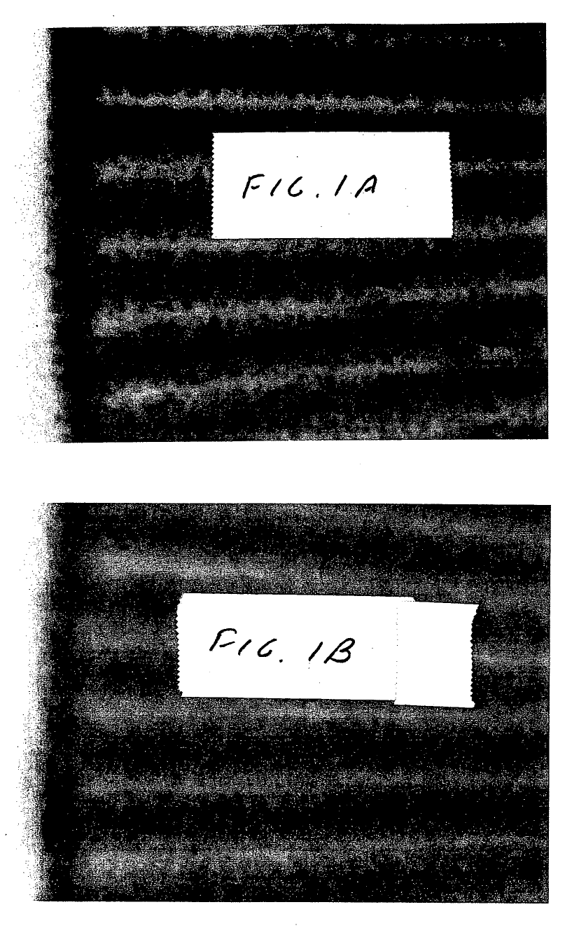

As illustrated in FIG. 1, the image recoding medium of the present invention is effective for providing a much improved image as compared images on standard recording medium. As shown in the Figure, dots on the present image recording medium are much tighter which results in sharper tighter images. Color is more saturated and less muddy. Further, the image recoding medium of the present invention (FIG. 1A) provide a much deeper and richer color quality and less of a glassine quality. As shown in FIG. 1, the dots on the present image recording medium (FIG. 1A) were at least about 25% sharper than those on standard recording medium (FIG. 1B).

While not intending to be bound by any theory, the combination of a support substrate, primer and ink-receptive layer where both the primer and ink-receptive layer include TiO₂ is effective for providing a very high quality image recording medium. The inclusion of TiO₂ results in a bright white pigment quite unlike the clear coatings of the prior art and can yield photograph quality paper when applied to poor quality paper, such as brown paper. Moreover, the resulting bright white pigment produces a high print quality surface for any substrate that is of less than optimal quality, including canvases, textiles, papers, polymer films, and the like. The inclusion of TiO₂ is effective for producing a pigment coating that has better clarity than the pigment inherent in the less than optimal quality printing substrates. This results in a pigment coat that captures pigment as well. The pigment coat of the present invention avoids the problems inherent with the previous attempts to make poorer quality substrates have the look and function of higher quality substrates, namely, ambering and color shifting of the colors applied to the coated substrate. The present invention prevents ambering and color shifting, thereby creating the appearance of a higher quality substrate.

Moreover, the preferred embodiment of the present invention provides for color saturation that is substantially improved over the coatings of the prior art. The increased color saturation allows for an additional increase in the clarity and sharpness of the displayed image and a greater color gambit to be shown.

The enhanced white point provided by the image recording medium of the invention allows for the image that is applied to the medium to have greater clarity and brightness, since the coating composition captures the pigment of the image paced thereon. Thus the image recording medium eliminates the “mirror writing” appearance inherent in printing on an ink-receptive clear coat. The white point of the present invention is substantially equal to or greater than the white points of high quality printing substrates, thereby increasing clarity and sharpness of the displayed image. White point may be measured by methods known in the art.

Support Substrate

The support substrate may be any opaque support known in the art such as canvas, paper, coated paper, synthetic paper, resin-coated paper, pigment-containing opaque film and foamed film. Particularly useful support substrates which may be utilized include for example canvas, recycled paper, and brown paper. The thickness of the support substrate may be selected according to the intended application and is generally about 5 to about 250 μm, more preferably about 50 to about 200 μm.

In an important aspect, the support substrate is a poly cotton 55%/45% 84×28 construction 16/10 yarn size. These sizes are effective for providing a texture and thickness that is compatible with desktop printers and is especially effective for use photography and art applications.

In another important aspect, canvas rolls are woven in about 2 to about 3000 yard lengths without any seams. Minimization of seams makes subsequent manufacturing easier and less wasteful.

Support substrates useful in the present invention are first cold bleached and washed to remove yellow color in the cotton and to remove the sizing the mill puts in the substrate when it is made. The bleached and washed substrate is then sized. Known sizing agents, such as acrylic or styrene acrylic sizing agents may be used.

In one aspect, the sizing agent may be an anionically-stabilized polymer latex which is an emulsion or dispersion formed from a polymer, an anionic surfactant, and water. Polyurethane, acrylic, or polyurethane-acrylic latex is preferable, but any waterborne anionically-stabilized polymer latex may be used. The preferred latexes are those having at least a 30% solids content, with greater than 50% solids being more preferred. One preferred example of an anionically-stabilized polyurethane latex is EX-62-655 (40% solids), available from Stahl. A suitable anionically-stabilized polyurethane-acrylic latex is Paranol T-6330 (50% solids), available from Parachem. Examples of suitable anionic surfactants for use in the polymer dispersion include, but are not limited to, poly-acrylic acid copolymers, sodium laurel sulfate, aryl and alkyl benzene sulfonate like, but not limited to, the proprietary Rhodacal DS-10 (from Rhodia).

In a preferred aspect, the substrate is sized with 12% of Paranol (Parachem), which is an acrylic sizing. Sizing is effective for providing water resistance to the substrate as well as adding a hand and an adhesive surface for the primer coat to bond to. The substrate is then framed, dried, inspected and rolled ready to be primed.

Primer

Primers which may be utilized include acrylic based coatings with added surfactant. Particularly useful acrylic based primers include acrylic primers that have at least about 40% solids, preferably about 45 to about 55% solids, and most preferably about 49% solids. Such primers are available from manufacturers such as Parachem.

As used herein, “acrylic polymer” means a polymer or copolymer of the following “acrylic monomers” which monomers may be substituted with one or more activated acetylenic groups according to the invention. 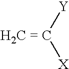
wherein
y=CH₃ or H 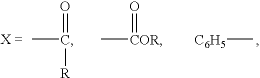
   or tolyl
R=straight chain or branched alkyls having 1 to 12 carbons, 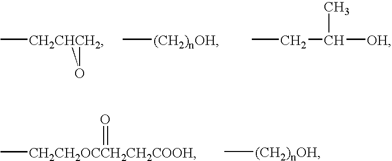
and H
n=2 to 7.

In the case of hydroxy-substituted alkyl acrylates the monomers may include members selected from the group consisting of the following esters of acrylic or methacrylic acid and aliphatic glycols: 2-hydroxy ethyl acrylate; 3-chloro-2-hydroxypropyl acrylate; 2-hydroxy-1-methylethyl acrylate; 2-hydroxypropyl acrylate; 3-hydroxypropyl acrylate; 2,3-dihydroxypropyl acrylate; 2-hydroxybutyl acrylate; 4-hydroxybutyl acrylate; diethylene glycol acrylate; 5-hydroxypentyl acrylate; 6-hydroxyhexyl acrylate; triethyleneglycol acrylate; 7-hydroxyheptyl acrylate; 2-hydroxy-1-methylethyl methacrylate; 2-hydroxy propyl methacrylate; 3-hydroxypropyl methacrylate; 2,3-dihydroxypropyl methacrylate; 2-hydroxybutyl methacrylate; 4-hydroxybutyl methacrylate; 3,4-dihydroxybutyl methacrylate; 5-hydroxypentyl methacrylate; 6-hydroxyhexyl methacrylate; 1,3-dimethyl-3-hydroxybutyl methacrylate; 5,6-dihydroxyhexyl methacrylate; and 7-hydroxyheptyl methacrylate.

The monomers such as the above acrylic monomers which provide the polymer are α,β unsaturated monomers which are free radically polymerized through the double bond in the monomer.

In an important aspect, an amount of surfactant effective for allowing the coating to be foamed is included in the primer. Air is injected and precisely measured in the coating. The foamed coating is then placed in a 16 oz cup and weighed (cup weight). In this aspect, an amount of air is injected into the primer/surfactant blend that is effective for providing a weight of primer/surfactant in a 16 oz cup of about 101 grams at about a 49% solids level.

Primer is applied to the substrate using a knife over roll. As the coating is applied, the knife cuts on to the canvas passing under it to provide an effective amount of coating in one pass. Since the coating is foamed it has a vertical height that allows for the deposit of a precise layer of coating that is sitting on top of the canvas. Since nothing is absorbed into the support substrate, the coat weight of the primer is about 25% to about 35% less than the weight of a primer that does not include surfactant at the indicated levels. In an important aspect, the primer is applied at an amount of about 2 to about 3 ounces per square yard, preferably about 2.4 to about 2.8 ounces per square yard, and most preferably about 2.5 ounces per square yard, which about 1 oz. less than known substrates. In important aspect, only single layer of primer needs to be applied to the support substrate.

In another important aspect, foamed primer provides significantly improved dry times. When applied as a foam, the primer dries about 35 to about 45% faster, preferably about 40% faster than non-foamed primer, which cuts production cost. The enhanced dry times also are effective for providing an image that is less likely to smudge.

After applying primer to the substrate and after oven drying, the primer coated substrate is passed through rollers that crush the substrate at about 7 to about 8 tons per square inch, preferably about 7.5 tons per square inch. After the crush the substrate is inspected as it is slit and rolled. This crush creates a very smooth and uniform surface that has a micro cellular technology that enhances binding to the ink-receptive coating.

Ink-Receptive Coating

The ink-receptive coating layer may contain various polymers for improving the drying property of the ink, the film-forming properties of the ink-receptive coating layer, the gloss and the sharpness of the image. Examples of useful polymers include various gelatins such as lime-treated gelatin, acid-treated gelatin, enzyme-treated gelatin, gelatin derivatives and reaction products of gelatins with anhydrides of dibasic organic acids such as phthalic acid, maleic acid and fumaric acid; non-modified polyvinyl alcohols of various saponification degrees, carboxy-modified, cation-modified and amphoteric polyvinyl alcohols and derivatives thereof; starches such as oxidized starch, cationized starch and etherified starch; cellulose derivatives such as carboxymethyl cellulose and hydroxyethyl cellulose; synthetic polymers such as polyvinyl pyrrolidone, polyvinylpyridium halide, sodium polyacrylate, salts of acrylic acid-methacrylic acid copolymer, polyethylene glycol, polypropylene glycol, polyvinyl ether, alkylvinyl ether-maleic anhydride copolymers, styrene-maleic anhydride copolymer and salts thereof and polyethyleneimine; conjugated diene copolymer latexes such as styrene-butadiene copolymer and methyl methacrylate-butadiene copolymer; vinyl acetate polymer latexes such as polyvinyl acetate, vinyl acetate-maleate copolymer, vinyl acetate-acrylate copolymer and ethylene-vinyl acetate copolymer; latexes of acrylic polymers or copolymers such as acrylate polymers, methacrylate polymers, ethylene-acrylate copolymer and styrene-acrylate copolymer; vinylidene chloride copolymer latexes; functional group-modified polymer latexes obtained by modifying the above various polymers with monomers containing functional group such as carboxyl group; aqueous adhesives of thermosetting synthetic resins such as melamine resin and urea resin; and synthetic resin adhesives such as polymethyl methacrylate, polyurethane resin, unsaturated polyester resin, vinyl chloride-vinyl acetate copolymer, polyvinyl butyral and alkyd resin. These may be used each alone or in combination. The amount of these polymers is suitably in the range of about 2 to about 100 part by weight, preferably about 5 to 30 parts by weight based on 100 parts by weight of solid content.

The ink-receptive coating layer will have at least about 9 to about 15 weight % solids, in another aspect about 20 weight % solids, in another aspect about 20 to 30 weight % solids, and in another aspect about 22 to about 24 weight % solids. The inclusion of TiO2 is effective for providing the ink-receptive coating and the resulting image recording medium with the indicated white point and brightness. Examples of specific ink-receptive coatings that may be utilized include coatings from Intellicoat.

The polymers mentioned above having groups with the possibility of reacting with a crosslinking agent can be crosslinked or hardened to form essentially non water soluble layers. Such crosslinking bonds may be either covalent or ionic. Cross-linking or hardening of the layers allows for the modification of the physical properties of the layers, like for instance in water absorbency of the layer or in resistance against physical damage.

The crosslinking agents or hardeners are selected depending on the water soluble polymers used. Organic crosslinking agents and hardeners include for example aldehydes (such as formaldehyde; glyoxal or glutaraldehyde); N-methylol compounds (such as dimethylol urea or methylol dimethylhydantoin); dioxane derivatives (such as 2,3-dihydroxy dioxane); reactive vinyl compounds (such as 1,3,5-trisacrylolyl hexahy-dro-s-triazine or bis-(vinylsulfonyl) methyl ether); active halogen compounds (such as 2,4-dichloro-6-hydroxy-s-triazine); epoxides; aziridines; carbamoyl pyridinium compounds or mixtures of two or more of the above mentioned crosslinking agents. Inorganic crosslinking agents or hardeners include for example chromium alum, aluminum alum or boric acid. The layers may also contain reactive compounds that crosslink the layers under the influence of UV light, electron beams, X-ray beams or heat.

In an important aspect, the ink-receptive coating layer further includes pigments. Pigment which is especially useful is titanium dioxide (TiO₂₎. In this aspect, the ink-receptive coating layer includes about 4 to about 10 weight % TiO₂, preferably about 5 to about 7 weight %, and most preferably about 6 weight % TiO₂.

The ink-receptive coating layer may contain various surfactants for improving the sharpness of images. These surfactants may be any of anionic type, cationic type, nonionic type and betaine type; they may be of a low molecular weight or of a high molecular weight. These may be used each alone or in combination of two or more. Preferred examples of these surfactants are anionic surfactants such as long-chain alkylbenzene-sulfonate salts and long-chain, preferably branched-chain alkylsulfosuccinate esters, nonionic surfactants such as polyalkylene oxide ethers of long-chain, preferably branched-chain alkyl group-containing phenols and polyalkylene oxide ethers of long-chain alkyl alcohols, and fluorinated surfactants. The amount of the surfactant added to the ink-receptive coating layer is preferably 0.1 to 7% by weight, more preferably 0.5 to 3% by weight based on the dry solid weight of the ink-receptive coating layer.

The ink-receptive coating layer can be coated onto a support by any number of suitable procedures. Usual coating methods include extrusion coating, air knife coating, doctor blade coating, cascade coating or curtain coating. The coatings may also be applied using spray techniques. In an important aspect, the ink receptive coating is absorbed and bonds to the primed surface. Separation from the primed surface is a problem with other ink receptive products.

Numerous modifications and variations in practice of the invention are expected to occur to those skilled in the art upon consideration of the foregoing detailed description of the invention. Consequently, such modifications and variations are intended to be included within the scope of the following claims.

What is claimed is:

1. An image recording medium comprising:
a bleached and sized support substrate;
a foamed primer contacting the support substrate; and
an opaque ink receptive coating contacting the foamed primer.

2. The image recording medium of claim 1 wherein the support substrate is selected from the group consisting of canvas, recycled paper and brown paper.

3. The image recording medium of claim 2 wherein the substrate is canvas.

4. The image recording medium of claim 1 wherein the foamed primer is an acrylic primer blended with surfactant and TiO₂.

5. The image recording medium of claim 4 wherein the foamed primer includes about 18 to about 26 weight % TiO₂.

6. The image recording medium of claim 1 wherein the foamed primer has a white point of 84 or greater.

7. The image recording medium of claim 1 wherein the ink receptive coating is a resin based coating having at least about 9 weight % solids.

8. The image recording medium of claim 1 wherein the ink receptive coating includes at least about 4 weight % TiO₂.

9. The image recording medium of claim 1 wherein the ink receptive coating has an opacity of about 73% or greater.

10. The image recording medium of claim 1 wherein the ink receptive coating has a white point of about 95 or greater.

11. The image recording medium of claim 1 wherein the ink receptive coating has a brightness of about 95 or greater.

12. A method for producing an image recording medium comprising:
preparing a substrate by bleaching and sizing the support substrate;
foaming a primer and applying the foamed primer to the substrate, wherein the foamed primer is an acrylic based primer with surfactant; and
applying an opaque ink receptive coating on the primer.

13. The method of claim 12 wherein the support substrate is selected from the group consisting of canvas, recycled paper and brown paper.

14. The method of claim 13 wherein the substrate is canvas.

15. The method of claim 12 wherein the primer is foamed by injecting air into a blend of acrylic primer, surfactant and about 18 to about 26 weight % TiO₂.

16. The method of claim 12 wherein the primer is foamed, applied to the support substrate, dried and then passed through rollers to supply a force of about 7 tons per square inch.

17. The method of claim 12 wherein the ink receptive coating includes at least about 4 weight % TiO₂.

18. The method of claim 12 wherein the ink receptive coating has an opacity of about 73% or greater.

19. The method of claim 12 wherein the image recording medium has a white point of about 95 or greater.

20. The method of claim 12 wherein the image recording medium has a brightness of about 95 or greater.
